(19) United States
(12) Patent Application Publication
(10) Pub. No.: US 2015/0182918 A1
(43) Pub. Date: Jul. 2, 2015

(54) MULTI-PASS HYPERFILTRATION SYSTEM

(71) Applicant: Dow Global Technologies LLC, Midland, MI (US)

(72) Inventors: Jon E. Johnson, Plymouth, MN (US); Markus Busch, Tarragona (ES); Katariina Majamaa, Tarragona (ES); Steven Rosenberg, Shorewood, MN (US); Steven D. Jons, Eden Prairie, MN (US)

(73) Assignee: DOW GLOBAL TECHNOLOGIES LLC, Midland, MI (US)

(21) Appl. No.: 14/372,552

(22) PCT Filed: Feb. 20, 2013
(86) PCT No.: PCT/US2013/026788

§ 371 Date: Jul. 16, 2014

Related U.S. Application Data
(60) Provisional application No. 61/605,993, filed on Mar. 2, 2012.

(51) Int. Cl. B01D 63/12; B01D 61/02

(52) U.S. Cl. CPC B01D 63/12; B01D 61/025; B01D 2313/14; B01D 2317/02

(57) ABSTRACT

The present invention is directed toward a multi-pass hyperfiltration system (38) including at least two passes (42,44) of spiral wound modules positioned in series along a fluid pathway; including: a first pass is located upstream along the fluid pathway with respect to a second pass such that permeate from the first pass is directed along the fluid pathway (40) to the second pass, and each pass comprises a pressure vessel enclosing at least one spiral wound module, each module including at least one hyper-filtration membrane envelop and feed spacer sheet wound about a permeate collection tube, wherein the system is characterized by the first pass comprising a spiral wound module including a feed spacer sheet having a thickness greater 0.65 mm and the second pass comprising a spiral wound module including a feed spacer sheet having a thickness less than 0.65 mm.

### FIELD

The invention generally relates to multi-pass hyperfiltration systems including multiple operating units (trains) interconnected such that permeate from an upstream unit is utilized as feed in a downstream unit.

### INTRODUCTION

Spiral wound modules used in hyperfiltration include at least one membrane envelop and feed spacer sheet wound about a permeate collection tube. The use of a thinner feed spacer sheet allows more active membrane area to be packed within a spiral wound module while maintaining a given diameter. While the incorporation of additional active membrane within the module generally improves separation efficiency, the use of thinner feed spacers can lead to increased fouling particularly with feed liquids having total organic content (TOC) values greater than 1 ppm, (as measured by ASTM D 4839-03). Fouling in turn leads to reduced flux and increased pressure loss.

### SUMMARY

A multi-pass hyperfiltration system including at least two passes of spiral wound modules positioned in series along a fluid pathway. The system includes a first pass located upstream along the fluid pathway with respect to a second pass such that permeate from the first pass is directed along the fluid pathway to the second pass. Each pass includes a pressure vessel enclosing at least one spiral wound module, with each module comprising at least one hyperfiltration membrane envelop and feed spacer sheet wound about a permeate collection tube. The system is characterized by the first pass comprising a spiral wound module including a feed spacer sheet having a thickness greater than 0.65 mm and the second pass comprising a spiral wound module including a feed spacer sheet having a thickness less than 0.65 mm. Systems including this combination of features can achieve the benefits associated with thinner feed spacer sheets while reducing much of the fouling typically associated therewith.

### BRIEF DESCRIPTION OF THE DRAWINGS

FIG. 1 is a perspective, partially cut-away view of a spiral wound filtration module.

FIG. 2 is a schematic view of a multi-pass filtration system.

### DETAILED DESCRIPTION

The present invention includes spiral wound elements (“modules”) suitable for use in reverse osmosis (RO) and nanofiltration (NF). Such modules include one or more RO or NF membrane envelops and feed spacer sheets wound about a permeate collection tube. RO membranes used to form envelops are relatively impermeable to virtually all dissolved salts and typically reject more than about 95% of salts having monovalent ions such as sodium chloride. RO membranes also typically reject more than about 95% of inorganic molecules as well as organic molecules with molecular weights greater than approximately 100 Daltons. NF membranes are more permeable than RO membranes and typically reject less than about 95% of salts having monovalent ions while rejecting more than about 50% (and often more than 90%) of salts having divalent ions—depending upon the species of divalent ion. NF membranes also typically reject particles in the nanometer range as well as organic molecules having molecular weights greater than approximately 200 to 500 Daltons. For purposes of the present description, the term “hyperfiltration” collectively describes RO and NF.

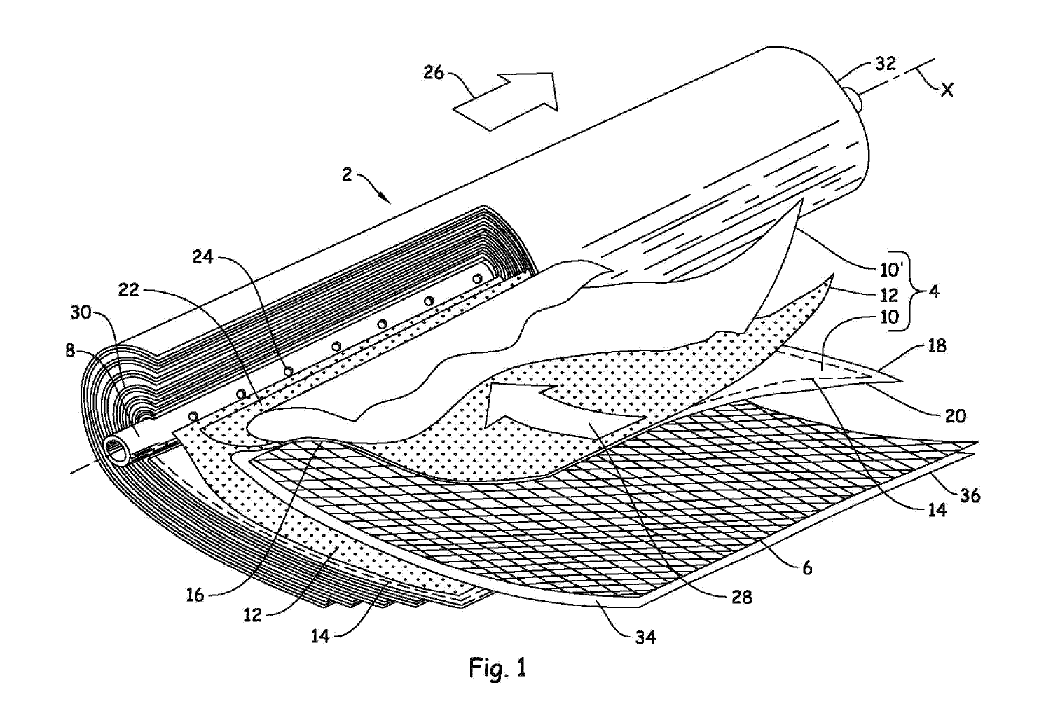

A representative spiral wound filtration module is generally shown at 2 in FIG. 1. The module (2) is formed by concentrically winding one or more membrane envelopes (4) and feed spacer sheet(s) (“feed spacers”) (6) about a permeate collection tube (8). Each membrane envelope (4) preferably comprises two substantially rectangular sections of membrane sheet (10, 10′). Each section of membrane sheet (10, 10′) has a membrane or front side (34) and support or back side (36). The membrane envelope (4) is formed by overlaying membrane sheets (10, 10′) and aligning their edges. In a preferred embodiment, the sections (10, 10′) of membrane sheet surround a permeate channel spacer sheet (“permeate spacer”) (12). This sandwich-type structure is secured together, e.g. by sealant (14), along three edges (16, 18, 20) to form an envelope (4) while a fourth edge, i.e. “proximal edge” (22) abuts the permeate collection tube (8) so that the inside portion of the envelope (4) (and optional permeate spacer (12)) is in fluid communication with a plurality of openings (24) extending along the length of the permeate collection tube (8). The module (2) preferably comprises a plurality of membrane envelopes (4) separated by a plurality of feed spacers sheets (6). In the illustrated embodiment, membrane envelopes (4) are formed by joining the back side (36) surfaces of adjacently positioned membrane leaf packets. A membrane leaf packet comprises a substantially rectangular membrane sheet (10) folded upon itself to define two membrane “leaves” wherein the front sides (34) of each leaf are facing each other and the fold is axially aligned with the proximal edge (22) of the membrane envelope (4), i.e. parallel with the permeate collection tube (8). A feed spacer sheet (6) is shown located between facing front sides (34) of the folded membrane sheet (10). The feed spacer sheet (6) facilitates flow of feed fluid in an axial direction (i.e. parallel with the permeate collection tube (8)) through the module (2). While not shown, additional intermediate layers may also be included in the assembly. Representative examples of membrane leaf packets and their fabrication are further described in U.S. Pat. No. 7,875,177 to Haynes et al.

During module fabrication, permeate spacer sheets (12) may be attached about the circumference of the permeate collection tube (8) with membrane leaf packets interleaved therebetween. The back sides (36) of adjacently positioned membrane leaves (10, 10′) are sealed about portions of their periphery (16, 18, 20) to enclose the permeate spacer sheet (12) to form a membrane envelope (4). Suitable techniques for attaching the permeate spacer sheet to the permeate collection tube are described in U.S. Pat. No. 5,538,642 to Solie. The membrane envelope(s) (4) and feed spacer(s) (6) are wound or “rolled” concentrically about the permeate collection tube (8) to form two opposing scroll faces (30, 32) at opposing ends and the resulting spiral bundle is held in place, such as by tape or other means. The scroll faces of the (30, 32) may then be trimmed and a sealant may optionally be applied at the junction between the scroll face (30, 32) and permeate collection tube (8), as described in U.S. Pat. No. 7,951,295 to Larson et al. Long glass fibers may be wound about the partially constructed module and resin (e.g. liquid epoxy) applied and hardened. In an alternative embodiment, tape may be applied upon the circumference of the wound module as described in US U.S. 2011/0094660 to McCollam. The ends of modules may be fitted with an anti-telescoping device or end cap (not shown) designed to prevent membrane envelopes from shifting under the pressure differential between the inlet and outlet scroll ends of the module. The end cap is commonly fitted with an elastomeric seal (not shown) to form a tight fluid connection between the module and a pressure vessel (not shown). Examples of end cap designs include those described in U.S. Pat. No. 6,632,356 to Hallan, et al. and U.S. 2011/0042294 to Bonta et al along with FilmTec Corporation's iLECFM interlocking end caps. The outer housing of a module may include fluid seals to provide a seal within the pressure vessel as described in U.S. Pat. Nos. 6,299,772 and 6,066,254 to Huschke et al. and U.S. Pat. No. 8,110,016 to McCollam.

Materials for constructing various components of spiral wound modules are well known in the art. Suitable sealants for sealing membrane envelopes include urethanes, epoxies, silicones, acrylates, hot melt adhesives and UV curable adhesives. While less common, other sealing means may also be used such as application of heat, pressure, ultrasonic welding and tape. Permeate collection tubes are typically made from plastic materials such as acrylonitrile-butadiene-styrene, polyvinyl chloride, polysulfone, poly (phenylene oxide), polystyrene, polypropylene, polyethylene or the like. Tricot polyester materials are commonly used as permeate spacers. Additional permeate spacers are described in U.S. 2010/0006504. Representative feed spacers include polyethylene, polyester, and polypropylene mesh materials such as those commercially available under the trade name VEXAR™ from Conwed Plastics. Preferred feed spacers are described in U.S. Pat. No. 6,881,336 to Johnson.

The membrane sheet is not particularly limited and a wide variety of materials may be used, e.g. cellulose acetate materials, polysulfone, polyether sulfone, polyamides, polyvinylidene fluoride, etc. A preferred membrane sheet includes FilmTec Corporation's FT-30™ type membranes, i.e. a flat sheet composite membrane comprising a backing layer (back side) of a nonwoven backing web (e.g. a non-woven fabric such as polyester fiber fabric available from Awa Paper Company), a middle layer comprising a porous support having a typical thickness of about 25-125 μm and top discriminating layer (front side) comprising a thin film polyamide layer having a thickness typically less than about 1 micron, e.g. from 0.01 micron to 1 micron but more commonly from about 0.01 to 0.1 μm. The backing layer is not particularly limited but preferably comprises a non-woven fabric or fibrous web mat including fibers which may be orientated. Alternatively, a woven fabric such as sail cloth may be used. Representative examples are described in U.S. Pat. No. 4,214,994; U.S. Pat. No. 4,795,559; US 5,435,957; U.S. Pat. No. 5,919,026; U.S. Pat. No. 6,156,680; U.S. Pat. No. 2008/0295951 and U.S. Pat. No. 7,048,855. The porous support is typically a polymeric material having pore sizes which are of sufficient size to permit essentially unrestricted passage of permeate but not large enough so as to interfere with the bridging over of a thin film polyamide layer formed thereon. For example, the pore size of the support preferably ranges from about 0.001 to 0.5 μm. Non-limiting examples of porous supports include those made of: polysulfone, polyether sulfone, polyimide, polyamide, polyetherimide, polyacrylonitrile, poly(methyl methacrylate), polyethylene, polypropylene, and various halogenated polymers such as polyvinylidene fluoride. The discriminating layer is preferably formed by an interfacial polycondensation reaction between a polyfunctional amine monomer and a polyfunctional acyl halide monomer upon the surface of the microporous polymer layer. Due to its relative thinness, the polyamide layer is often described in terms of its coating coverage or loading upon the porous support, e.g. from about 2 to 5000 mg of polyamide per square meter surface area of porous support and more preferably from about 50 to 500 mg/m². The polyamide layer is preferably prepared by an interfacial polycondensation reaction between a polyfunctional amine monomer and a polyfunctional acyl halide monomer upon the surface of the porous support as described in U.S. Pat. No. 4,277,344 and U.S. Pat. No. 6,878,278. More specifically, the polyamide membrane layer may be prepared by interfacially polymerizing a polyfunctional amine monomer with a polyfunctional acyl halide monomer, (wherein each term is intended to refer both to the use of a single species or multiple species), on at least one surface of a porous support. As used herein, the term “polyamide” refers to a polymer in which amide linkages (—C(O)NH—) occur along the molecular chain. The polyfunctional amine and polyfunctional acyl halide monomers are most commonly applied to the porous support by way of a coating step from solution, wherein the polyfunctional amine monomer is typically coated from an aqueous-based or polar solution and the polyfunctional acyl halide from an organic-based or non-polar solution.

Arrows shown in FIG. 1 represent the approximate flow directions (26, 28) of feed and permeate fluid (also referred to as “product” or “filtrate”) during operation. Feed fluid enters the module (2) from an inlet scroll face (30) and flows across the front side(s) (34) of the membrane sheet(s) and exits the module (2) at the opposing outlet scroll face (32). Permeate fluid flows along the permeate spacer sheet (12) in a direction approximately perpendicular to the feed flow as indicated by arrow (28). Actual fluid flow paths vary with details of construction and operating conditions.

While modules are available in a variety of sizes, one common industrial RO module is available with a standard 8 inch (20.3 cm) diameter and 40 inch (101.6 cm) length. For a typical 8 inch diameter module, 26 to 30 individual membrane envelopes are wound around the permeate collection tube (i.e. for permeate collection tubes having an outer diameter of from about 1.5 to 1.9 inches (3.8 cm 4.8)).

The pressure vessels used in the present invention are not particularly limited but preferably include a solid structure capable of withstanding pressures associated with operating conditions. The vessel structure preferably includes a chamber having an inner periphery corresponding to that of the outer periphery of the spiral wound modules to be housed therein. The length of the chamber preferably corresponds to the combined length of the elements to be sequentially (axially) loaded, e.g. 1 to 8 elements, see U.S. 2007/0272628 to Mickols. The pressure vessel may also include one or more end plates that seal the chamber once loaded with modules. The vessel further includes at least one fluid inlet and outlet preferably located at opposite ends of the chamber. The orientation of the pressure vessel is not particularly limited, e.g. both horizontal and vertical orientations may be used. Examples of applicable pressure vessels, module arrangements and loading are described in: U.S. Pat. No. 6,074,595, U.S. Pat. No. 6,165,303, U.S. Pat. No. 6,299,772 and U.S. 2008/0308504. Manufacturers of pressure vessels include Pentair of Minneapolis Minn., Bekaert of Vista Calif. and Bel Composite of Beer Sheva, Israel. An individual pressure vessel or a group of vessels working together, each equipped with one or more modules, are commonly referred to as a “train” or “pass.” The vessel(s) within the pass may be arranged in one or more stages, wherein each stage contains one or more vessels operating in parallel with respect to a feed fluid. Multiple stages are arranged in series, whereby the concentrate fluid from an upstream stage is used as feed fluid for the downstream stage, while the permeate from each stage is collected without further reprocessing within the pass. Multi-pass hyperfiltration systems are constructed by interconnecting individual passes along a fluid path way as described in: U.S. Pat. No. 4,156,645, U.S. Pat. No. 6,187,200 and U.S. Pat. No. 7,144,511.

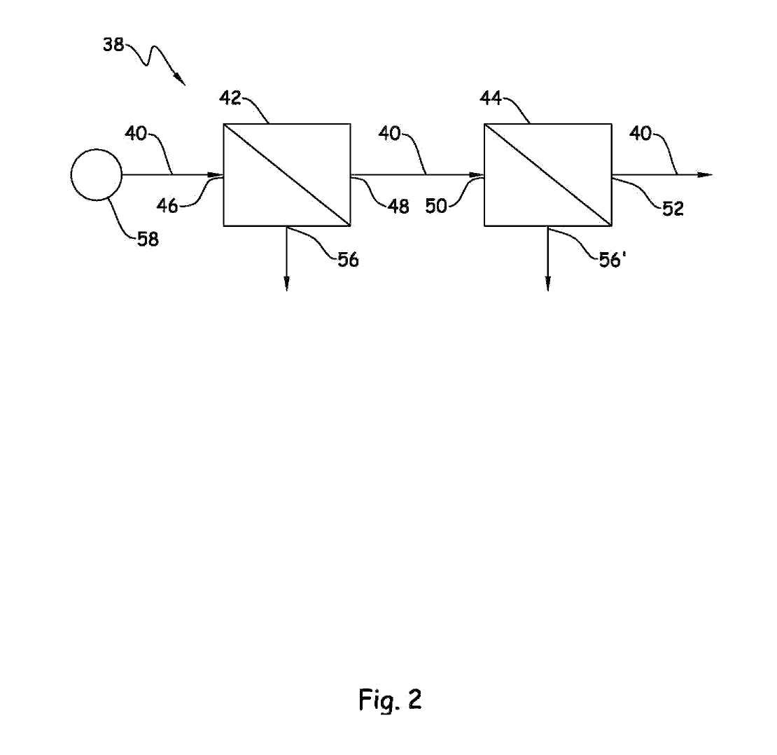

FIG. 2 illustrates a multi-pass filtration system (38) including two passes of spiral wound modules positioned in series along a fluid pathway (40) with a first pass (42) located upstream along the fluid pathway (40) with respect to a second pass (44). Each pass (42, 44) includes a pressure vessel enclosing at least one and preferably at least three spiral wound modules connected in series with each module comprising at least one hyperfiltration membrane envelop and feed spacer sheet wound about a permeate collection tube as previously described with reference to FIG. 1. In operation, pressurized feed liquid enters the first pass (42) via feed inlet (46). A first permeate liquid (filtrate) exits via outlet (48) and enters the second pass (44) via inlet (50). A second permeate liquid exits the second pass (44) via permeate outlet (52). Concentrate liquid exits both passes (42, 44) by way of concentrate outlets (56, 56′). Concentrate fluid may be discarded, recycled, used in a separate stage, or otherwise disposed of. While shown as including two passes, the system may include additional passes including optionally passes in parallel along the fluid pathway. In the embodiment illustrated in FIG. 2, the fluid pathway (40) comprises the inlets (46, 50), outlets (48, 52) first and second passes (42, 44) and piping therebetween. The system may further include pumps (58), valves and related equipment as is convention in the art.

The first pass (42) includes at least one spiral wound module including a feed spacer sheet having a thickness greater than 0.65 mm whereas the second pass (44) includes at least one spiral wound module including a feed spacer sheet having a thickness less than 0.65 mm. In one embodiment, the thickness of the feed spacer sheet of the first pass is from 0.7 mm to 1.2 mm and more preferably from 0.7 to 1 mm. In another embodiment, the thickness of the feed spacer sheet of the second pass is from 0.3 to 0.6 mm, and more preferably 0.4 to 0.56 mm. While the individual modules of a given pass need not be the same nor have identical feed spacer sheets, (e.g. see U.S. 2007/0272628 to Mickols), the feed spacer sheets of a given pass preferably meet the preceding criteria. For purposes of the present description, the thickness of the feed spacer sheet is determined by first measuring the combined thickness of the feed spacer and membrane envelope. This is preferably done using a fully assembled, non-pressurized module provided in a dry state. The combined thickness is the quotient of the scroll end-area and the length of the membrane envelope, measured perpendicular to the permeate collection tube. From the combined thickness, the thickness attributed by the membrane envelope (e.g. membrane sheets and permeate spacer sheet if present) is subtracted and the remaining thickness is that of the feed spacer sheet.

### EXAMPLES

Several two pass hyperfiltration system were tested. The general layout of the systems is illustrated in FIG. 2. The first pass consisted of a spiral wound module incorporating a standard (90° hydrodynamic angle) feed spacer sheet having a thickness of 0.71 mm (28 mil). The second pass consisted of a spiral wound module incorporating a standard feed spacer sheet having a thickness of 0.56 mm (22 mil). The systems were tested using pressurized pre-treated municipal waste water having a TOC of approximately 7-8 ppm as measured by ASTM D 4839-03 (persulfate oxidation). After over 60 days of continuous operation (at approx. 533 l/h), the spiral wound module of the second pass experience no measurable pressure loss.

By way of comparison, two additional systems were tested under the same operating conditions and liquid feed. Both comparison systems included a first pass of ultrafiltration (SPF-2880 pressurized ultrafiltration modules commercially available from The Dow Chemical Company) followed by a second pass of hyperfiltration. In comparative system A, the second pass of hyperfiltration was identical to the first pass described in the preceding paragraph and in comparison system B, the second pass was identical to the second pass described in the preceding paragraph, i.e. using a feed spacer sheet having a thickness of 0.71 mm (28 mil) and 0.56 mm (22 mil), respectively. After approximately 60 days of continuous operation (approx 537 l/h for UF, 533 l/h for hyperfiltration), comparison system A experienced a change in pressure loss of 58% whereas comparison system B experienced a change in pressure loss of 161%. As indicated by this result, the use of ultrafiltration was insufficient to prevent significant pressure loss in downstream hyperfiltration systems when utilizing feed liquids having TOC values above 1 ppm.

In preferred embodiments of the invention, the feed liquid has a TOC value of at least 1 ppm but more pronounced benefits are achieved using feed waters having TOC values of at least 3 ppm, 6 ppm or 7 ppm.

Many embodiments of the invention have been described and in some instances certain embodiments, selections, ranges, constituents, or other features have been characterized as being “preferred”. Such designations of “preferred” features should in no way be interpreted as an essential or critical aspect of the invention. Expressed ranges specifically include end points.

The entire content of each of the aforementioned patents and patent applications are incorporated herein by reference.

1. A multi-pass hyperfiltration system comprising at least two passes of spiral wound modules positioned in series along a fluid pathway, wherein;
a first pass is located upstream along the fluid pathway with respect to a second pass such that permeate from the first pass is directed along the fluid pathway to the second pass, and
wherein each pass comprises a pressure vessel enclosing at least one spiral wound module, the module comprising at least one hyperfiltration (RO or NF) membrane envelop and feed spacer sheet wound about a permeate collection tube;
the system being characterized by the first pass comprising a spiral wound module including a feed spacer sheet having a thickness of 0.7 to 1.2-mm and the second train comprising a spiral wound module including a feed spacer sheet having thicknesses of 0.3 to 0.6 mm.

2. The system of claim 1 wherein the second train comprises a spiral wound module including feed spacer sheet having a thickness less than or equal to 0.56 mm (2 mil).

3. (canceled)

4. The system of claim 1 wherein each pass comprises a pressure vessel enclosing at least two spiral wound modules connected in series, wherein all the spiral wound modules of a given pass are of the same type.

5. A method for filtering a liquid having a TOC value of at least 1 ppm, comprising
pressurizing a feed liquid and directing the feed liquid through a first pass of hyperfiltration to produce a first permeate liquid,
directing the first permeate liquid through a second pass of hyperfiltration to produce a second permeate liquid, wherein:
both passes comprises a pressure vessel enclosing at least one spiral wound module, the module comprising at least one hyperfiltration (RO or NF) membrane envelop and feed spacer sheet wound about a permeate collection tube and the first pass comprising a spiral wound module including a feed spacer sheet having a thickness pf 0.7 tp 1.2 mm and the second train comprising a spiral wound module including a feed spacer sheet having thicknessess of 0.3 to 0.6 mm.

6. The method of claim 5 wherein the second train comproses a spiral wound module including feed spacer sheet having a thickness less than or equal to 0.56 mm (22 mil).

7. (canceled)

8. The method of claim 5 wherein each pass comprises a pressure vessel enclosing at least two spiral wound modules connected in series wherein all the spiral wound modules on a given pass are of the same type.

9. (canceled)
